(19) United States
(12) Patent Application Publication
(10) Pub. No.: US 2023/0122089 A1
(43) Pub. Date: Apr. 20, 2023

(54) ENHANCED NOISE REDUCTION IN A VOICE ACTIVATED DEVICE

(71) Applicant: DSP Group Ltd., Herzliya (IL)

(72) Inventors: Yaakov CHEN, Raanana (IL); Moshe TZUR, Petah Tikva (IL)

(21) Appl. No.: 17/930,658

(22) Filed: Sep. 8, 2022

Related U.S. Application Data
(60) Provisional application No. 63/262,630, filed on Oct. 17, 2021.

(51) Int. Cl. G10L 21/0216; G10L 25/84

(52) U.S. Cl. CPC G10L 21/0216; G10L 25/84

(57) ABSTRACT

Noise suppression in audio signals received by a voice activated device is supported with motion sensors. Motion sensors may provide an indication of movement or motion information, such as the linear or rotational displacement of the voice activated device. A noise reduction unit, which is held in idle mode to conserve power, may be activated in response to an indication of movement. When activated, the noise reduction unit may adapt to environmental noise from the new location or orientation, and switch back to idle mode. When speech is subsequently detected in audio signals, the noise reduction unit has already adapted to the noise and accordingly may reduce noise in the audio signal with no delay when activated. Additionally or alternatively, motion information may be used by the noise reduction unit to quickly adapt to noise in the audio signal.

### CROSS-REFERENCE TO RELATED APPLICATION

This application claims priority and benefit under 35 USC § 119(e) to U.S. Provisional Patent Application No. 63/262,630, filed on Oct. 17, 2021, which is incorporated herein by reference in its entirety.

### TECHNICAL FIELD

The present implementations relate generally to voice activated devices, and specifically to systems and methods for noise reduction for voice activated devices.

### BACKGROUND OF RELATED ART

Voice activated devices provide hands-free operation by listening and responding to a user's voice. For example, a user may query a voice activated device for information (e.g., recipe, instructions, directions, and the like), to playback media content (e.g., music, videos, audiobooks, and the like), or to control various devices in the user's home or office environment (e.g., lights, thermostats, garage doors, and other home automation devices). Some voice activated devices may communicate with one or more network (e.g., cloud computing) resources to interpret and/or generate a response to the user's query. Further, some voice activated devices may first listen for a predefined “trigger word” or “wake word” before generating a query to be sent to the network resource.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Noise suppression in audio signals received by a voice activated device is supported with use of one or more motion sensors. The motion sensors may provide an indication of movement or motion information, such as the linear or rotational displacement of the voice activated device. A noise reduction unit in the voice activated device that is in idle mode to conserve power may be activated in response to an indication of movement. When activated, the noise reduction unit may adapt to environmental noise from the new location or orientation before switching back to idle mode. When speech is subsequently detected in audio signals, the noise reduction unit may be activated in response and noise in the audio signal suppressed with little or no delay. Additionally or alternatively, the motion information may be provided to the noise reduction unit and may be used to quickly adapt to noise in the audio signal.

In one aspect, a method of processing audio signals in a voice activated device includes sensing a motion of the voice activated device; switching a noise reduction unit in the voice activated device from an inactive mode to an active mode after sensing the motion; and performing noise reduction of audio signals received after sensing the motion.

In one aspect, a controller for a voice activated device includes a processing system comprising one or more processors coupled to and the at least one memory, the processing system configured to: sense a motion of the voice activated device; switch noise reduction in the voice activated device from an inactive mode to an active mode based at least in part on sensing the motion; and perform the noise reduction of audio signals received after the motion is sensed.

In one aspect, a voice activated device includes one or more motion sensors configured to sense a motion of the voice activated device; and a noise reduction unit configured to: switch from an inactive mode to an active mode based at least in part on the sensed motion; and perform noise reduction of audio signals received after the motion is sensed.

### BRIEF DESCRIPTION OF THE DRAWINGS

The present implementations are illustrated by way of example and are not intended to be limited by the figures of the accompanying drawings.

FIG. 1 shows an example a voice activated device.

FIG. 2 shows a timing diagram for an audio input signal and illustrates the performance of a voice activity detector.

FIG. 3 shows a timing diagram for an audio input signal and illustrates noise in the input signal after movement of the voice activated device.

FIG. 4 shows an example a voice activated device configured to detect movement, which is used to enhance noise reduction.

FIG. 5 shows a timing diagram for an audio input signal and illustrates noise reduction in the input signal in response to the detection of movement of the voice activated device.

FIG. 6 illustrates a voice activated device that is moved with respect to a sound source and adapts to the change in direction of the sound source based on detected motion information.

FIG. 7 shows a block diagram of an example voice activated device, according to some implementations.

FIG. 8 shows an illustrative flowchart depicting an example operation for a voice activated device, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the described functions or methods. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory. The term “voice activated device” or “voice-enabled device” as used herein, may refer to any device capable of performing voice search operations and/or responding to voice queries. Examples of voice activated devices may include, but are not limited to, smart speakers, home automation devices, voice command devices, virtual assistants, personal computing devices (e.g., desktop computers, laptop computers, tablets, web browsers, and personal digital assistants (PDAs)), data input devices (e.g., remote controls and mice), data output devices (e.g., display screens and printers), remote terminals, kiosks, video game machines (e.g., video game consoles, portable gaming devices, and the like), communication devices (e.g., cellular phones such as smart phones), media devices (e.g., recorders, editors, and players such as televisions, set-top boxes, music players, digital photo frames, and digital cameras), and the like.

Voice activated devices provide hands-free operation by listening and responding to a user's voice. Many voice activated devices are always on so that they may receive and respond to voice commands at any time. As such, the average power consumption is subject to strict requirements to sustain battery power for a reasonable time. To meet the strict power requirements, a voice activated device may include a voice activity detector (VAD) that is used to detect the presence or absence of speech within a received audio signal. When speech is absent, power consumption may be reduced, for example, by placing other components of the voice activated device in an idle mode. Once speech is detected by the VAD, the other components are transitioned from idle mode to an active mode. Upon activation, a noise reduction component ideally will suppress noise in the received audio signal so that speech may be easily distinguished so that the voice activated device may respond to the user's voice, e.g., detect a keyword spoken by a user, receive and analyze a query, etc.

Aspects of the present disclosure recognize the problems associated with noise suppression after the occurrence of a change in location or orientation of a voice activated device. For example, the suppression of noise in an audio signal may be dependent on the relative location or orientation of the voice activated device with respect to a sound source, e.g., a noise source or a speech source. The voice activated device, however, may change location, orientation, or both, while the noise reduction component is in idle mode. Upon activation of the noise reduction component, e.g., in response to the detection of speech by the VAD, the noise reduction component may attempt to suppress noise in the audio signal based on the previous location or orientation, which may not be applicable to the current location or orientation. Consequently, the noise reduction component may be unable to adequately suppress noise (or equivalently enhance the desired speech source) in the audio signal immediately and may be required to adapt to the new location or orientation of the sound source before speech (or other signal) in the audio signal can be accurately distinguished, resulting in delays and possibly missing a keyword spoken by a user.

Various aspects relate generally to the suppression of noise in an audio signal by a voice activated device, and more particularly, to adapting to noise in the environment after movement of the voice activated device. In some implementations, the noise reduction unit may be switched from an inactive mode to an active mode in response to detection of movement of the voice activated device. The noise reduction unit may adapt to environmental noise in the audio signals from the new location or orientation before switching back to the inactive mode. When speech is subsequently detected, the noise reduction unit may be switched to active mode and accurately suppress environmental noise in the audio signal with little or no delay. In some implementations, the noise reduction unit may use motion information determined from the detection of movement of the voice activated device. The motion information, for example, may include a measure of the relative change in position or orientation of the voice activated device. When speech is subsequently detected, the noise reduction unit may switch to active mode and use the motion information to quickly adapt to the new location or orientation and accurately suppress environmental noise in the audio signal. For example, the motion information may be used to alter or steer the direction of beam forming that is used for suppression of noise in the audio signal.

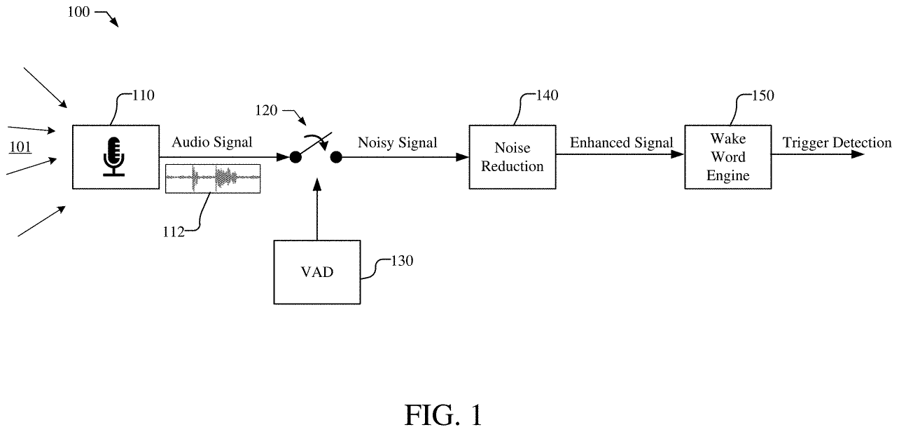

FIG. 1, for example, illustrates an example of a voice activated device 100 that does not detect movement and, accordingly, cannot adaptively adjust noise suppression in response to the detection of movement. The voice activated device 100 is illustrated as including a microphone 110, a switch 120, a voice activity detector (VAD) 130, a noise reduction unit 140, and a wake word engine 150. The voice activated device 100 may include additional components that are not shown, such as a speech analysis unit, an application processor, communication unit, etc.

The microphone 110 illustrated in FIG. 1 may be, for example, a single microphone or a microphone array. The microphone 110 receives sound 101 generated by a human voice and/or other audio source or sources, including environmental noise sources, and provides an audio signal 112. The VAD 130 receives the audio signal 112 and determines whether speech or other target sound is present in the audio signal 112. The VAD 130 may be implemented in hardware and/or software or may be included in the microphone 110, such as in a VM3011 microphone produced by Vesper Technologies, Inc., or may be a part of a codec chip or in any component in the audio flow.

When speech or other target sound is absent from the audio signal 112, the power consumption of the voice activated device 100 may be reduced by placing other units, such as the noise reduction unit 140 and the wake word engine 150, in idle mode. FIG. 1, as an example, illustrates enablement of the noise reduction unit 140 and the wake word engine 150 in response to the detection of speech or other target sound in the audio signal 112 by the switch 120. It should be understood that switch 120 is merely illustrated as an example of power management. For example, the VAD 130 may control the power supply to one or more components based on the presence or absence of speech or other target sound from the audio signal 112. For example, in some implementations, components such as the noise reduction unit 140 and the wake word engine 150 may be continually connected to the microphone 110, but may be switched from idle mode to active mode in response to the VAD 130 detecting speech or other target sound from the audio signal 112, and may be switched from active mode to idle mode in response to the VAD 130 detecting that speech or other target sound is absent from the audio signal 112.

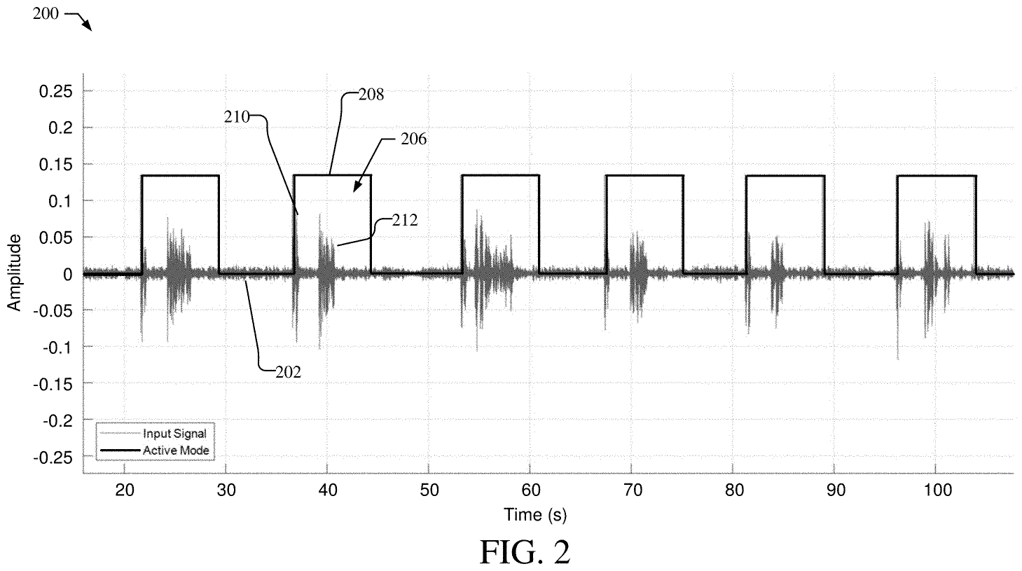

FIG. 2 illustrates a timing diagram 200 with a simulation of an audio input signal 202 and performance of the VAD 130. In FIG. 2, the X axis represents time and the Y axis represents amplitude of the audio signal.

As illustrated, the input signal 202 may include an amount of noise and may further include occasional periods where speech 206 (or other target sound) is present. When the VAD 130 detects speech 206 in the input signal 202, the VAD 130 enables an active mode 208, during which other components (e.g., the noise reduction unit 140 and the wake word engine 150) may process the input signal 202. For example, as illustrated in FIG. 2, the speech 206 may be used by VAD 130 to enable the active mode 208 of other components, and a wake word 210 may be used by the wake word engine 150 to trigger activation of other components, such as a speech analysis unit, an application processor, a communication unit, and the like, to analyze a query 212. After a predetermined amount of time, e.g., after speech 206 is no longer detected in the input signal 202, the active mode 208 may be disabled thereby placing other components (e.g., the noise reduction unit 140, the wake word engine 150, etc.) in idle mode.

As illustrated in FIG. 1, once enabled (i.e., placed in active mode) the noise reduction unit 140 receives a noisy signal. The noise reduction unit 140 may process the noisy signal, e.g., adapt to the noise in the audio signal, and provide an enhanced signal to other components, e.g., the wake word engine 150. FIG. 1, for example, illustrates an enhanced signal to the wake word engine 150, which upon detection of a wake word may trigger activation of other components, such as a speech analysis unit, an application processor, a communication unit, and the like.

The noise reduction unit 140 may apply one or more noise reduction techniques. For example, the noise reduction unit 140 may apply one or more speech enhancement, signal-to-noise ratio (SNR) enhancements, such as noise reduction or suppression, adaptive beam forming, adaptive interference cancelation, adaptive noise cancelation, etc.

For example, in an implementation where the microphone 110 is a single microphone, the noise reduction technique used by the noise reduction unit 140 may be highly dependent on the noise energy level, e.g., only temporal information may be considered during filtering of the audio signal 112. In such an implementation, sudden changes in noise level, e.g., which may be caused by movement of the voice activated device 100 while in “sleep mode,” may be mistakenly classified as speech or other target sound in the audio signal 112.

In an implementation where the microphone 110 is a microphone array, the noise reduction technique used by the noise reduction unit 140 may additionally or alternatively be spatially based. For example, adaptive beam forming may be used implemented by a beam-forming unit (not shown) to track the direction of noise sources and/or speech sources, and directions, and the noise reduction unit 140 may apply spatial filtering for speech enhancement or to increase the SNR of the output signal from the beam forming. Speech enhancement, for example, generally includes decreasing the amount of distortion in the speech signal as well as increasing the SNR. In order to successfully track the noise direction using beam forming, “noise-only” signal frames (i.e., a period of time during which the audio signal includes only noise and does not include speech or other target sound) are used, over which the adaptation may be applied. If “noise-only” signal frames are not available, the beam forming may not converge to the correct noise direction, particularly if dynamic environments are considered, yielding sub-optimal performance, and which may even suppress the speech signal in the audio signal 112 by mistake.

Thus, the voice activated device 100 may apply one or more noise reduction techniques that are dependent on location, orientation or both location and orientation. If the location and/or orientation of the voice activated device 100 is changed, however, the location and/or orientation dependent technique method for noise reduction may not perform correctly until the noise reduction unit 140 is able to adapt to noise in the current location and/or orientation, which requires some amount of time. Accordingly, if the voice activated device 100 is in sleep mode, e.g., with components such as the noise reduction unit 140 in idle mode, and the location and/or orientation of the voice activated device 100 is changed, i.e., the voice activated device 100 is moved, once the VAD 130 activates the noise reduction unit 140 in response to speech or other target sound, noise reduction performed by the noise reduction unit 140 may not operate properly for a period of time. Consequently, the noise reduction unit 140 may not adequately suppress noise and components, such as the wake word engine 150, may not be able to distinguish between speech and noise and may miss a wake word or other query.

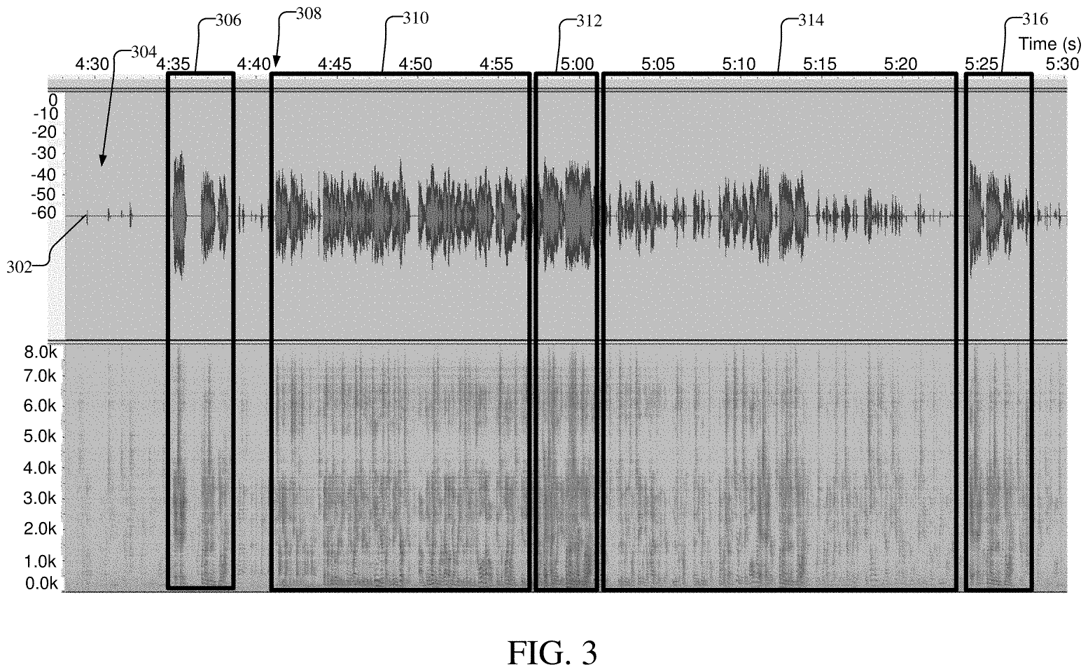

FIG. 3 illustrates a timing diagram 300 for an audio input signal 302 and illustrates noise in the input signal after movement of the voice activated device. The X axis in FIG. 3 represents time and the Y axis represents amplitude of an input signal 302. FIG. 3 shows a sequence of events that illustrate a noise reduction unit attempting to reduce noise in the input signal 302 after the location and/or orientation of a voice activated device is changed.

As illustrated by arrow 304 in FIG. 3, the noise reduction unit may initially suppress environmental noise in the input signal 302, e.g., after being initially adapted to the environmental noise. When speech is present in the input signal 302 at box 306, it is clear and easily distinguished from the environmental noise.

After the location and/or orientation of a voice activated device is changed at arrow 308, the noise reduction unit is no longer able to suppress environmental noise in the input signal 302 in box 310 based on the initial adaptation to the environmental noise. Box 312 illustrates speech in a noisy input signal 302 after the noise reduction unit is switched to active mode after the voice activated device has been moved. The speech in box 312, for example, may be difficult to distinguish from noise by the wake word engine or other components, which may result in a wake word or other information being missed.

As illustrated in box 314, over time the noise reduction unit adapts to the environmental noise until the environmental noise is adequately suppressed so that speech may be clearly distinguished from the noise, as illustrated in box 316.

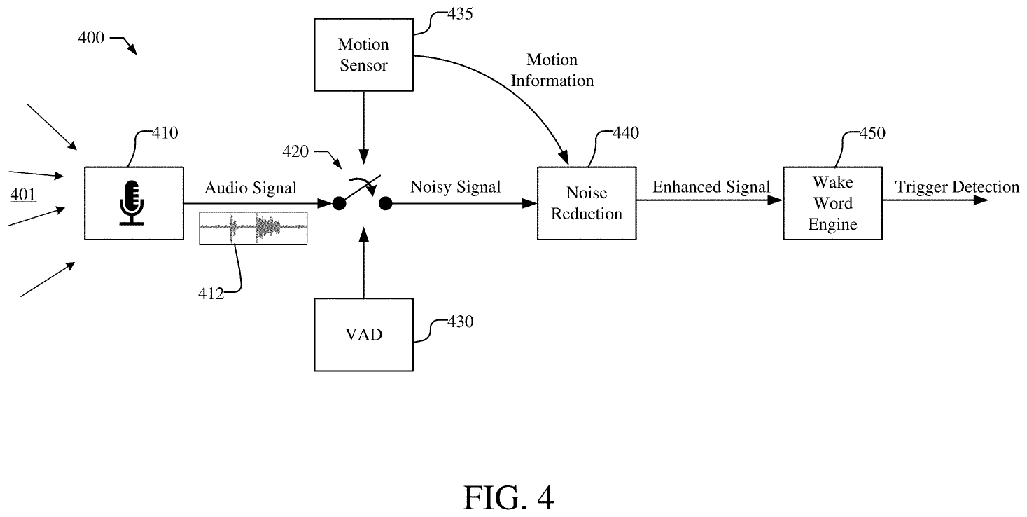

FIG. 4 illustrates an example of a voice activated device 400 configured to detect movement of the voice activated device 400, which may be used to enhance noise reduction in response to the movement. The voice activated device 400 is illustrated as including a microphone 410, a switch 420, a voice activity detector (VAD) 430, a noise reduction unit 440, and a wake word engine 450, which may be similar to the microphone 110, the switch 120, the voice activity detector (VAD) 130, the noise reduction unit 140, and the wake word engine 150, respectively, as discussed in reference to FIG. 1. The voice activated device 400 further includes a motion sensor 435, which is illustrated as controlling switch 420 and/or providing motion information to the noise reduction unit 440. The voice activated device 400 may include additional components that are not shown, such as a speech analysis unit, an application processor, communication unit, etc.

The microphone 410 illustrated in FIG. 4 may be, for example, a single microphone or a microphone array. The microphone 410 receives sound 401 generated by a human voice and/or other audio source or sources, including environmental noise sources, and provides an audio signal 412. The VAD 430 receives the audio signal 412 and determines whether speech or other target sound is present in the audio signal 412. The VAD 430 may be implemented in hardware and/or software or may be included in the microphone 410, such as in a VM3011 microphone produced by Vesper Technologies, Inc., or may be a part of a codec chip or in any component in the audio flow.

The switch 420 is illustrated as an example of power management so that components, such as the noise reduction unit 440, wake word engine 450, etc., may be placed in idle mode until the VAD 430 detects the presence of speech or other target sound in the audio signal 412. Once the VAD 430 detects the presence of speech or other target sound, the components, such as the noise reduction unit 440, wake word engine 450, etc., may be switched to an active mode (illustrated by use of switch 420), e.g., as discussed in FIGS. 1 and 2.

The voice activated device 400 additionally includes the motion sensor 435 that is capable of detecting linear or rotational motion, or a combination thereof. The motion sensor 435, for example, may include one or more accelerometers, one or more gyroscopes, a magnetometer, a digital compass, or any combination thereof. In some implementations, the motion sensor 435 may sense the occurrence of linear movement or rotational movement and may produce a control signal (to switch 420) when movement is sensed. In some implementations, the motion sensor 435 may additionally or alternatively measure the motion, e.g., the linear displacement and/or rotational displacement, and provide the motion information to the noise reduction unit 440.

The motion sensor 435, like VAD 430, may be always or almost always activate and may sense movement (and/or measurement the movement) while other components, such as the noise reduction unit 440, wake word engine 450, etc., are in idle mode.

In one implementation, when movement is sensed by the motion sensor 435, the motion sensor 435 may provide a control signal that switches one or more components, such as the noise reduction unit 440, wake word engine 450, etc., from an idle mode to an active mode. It should be understood that the motion sensor 435 may operate separately from the VAD 430, i.e., components may transition from idle mode to active mode based on motion detected by the motion sensor 435 without requiring that speech (or other target sound) is also detected in the audio signal by the VAD 430. FIG. 4, for example, illustrates the motion sensor 435 providing the control signal to switch 420 to switch other components to active mode, but any power management technique may be used. For example, the motion sensor 435 may control the power supply to one or more components based on detected movement of the voice activated device 400. For example, in some implementations, components such as the noise reduction unit 440 and the wake word engine 450 may be continually connected to the microphone 410 but may be switched from idle mode to active mode in response to the motion sensor 435 sensing movement of the voice activated device 400.

The noise reduction unit 440 may apply one or more noise reduction techniques similar to noise reduction unit 140, discussed above. For example, the noise reduction unit 140 may apply one or more speech enhancement, signal-to-noise ratio (SNR) enhancements, such as noise reduction or suppression, adaptive beam forming, adaptive interference cancelation, adaptive noise cancelation, etc. The one or more noise reduction techniques applied by the noise reduction unit 440 may be dependent on location, orientation or both location and orientation.

By switching the noise reduction unit 440 to active mode in response to the detection of movement (without also requiring the detection of speech by the VAD 430), the noise reduction unit 440 may adapt to environmental noise at the new location and/or orientation without the presence of speech in the audio signal 412. Accordingly, the noise reduction unit 440 receives “noise-only” signal frames and is able to adapt to any new noise features, such as direction of source, energy level, etc., once the position and/or orientation of the voice activated device 400 has changed. In some implementations, the noise reduction unit 440 may be switched to the active mode once movement of the voice activated device 400 is detected and may begin to adapt to changes in location and/or orientation even during movement of the voice activated device or the noise reduction unit 440 may be switched to the active mode after the movement detected by the motion sensor 435 is complete.

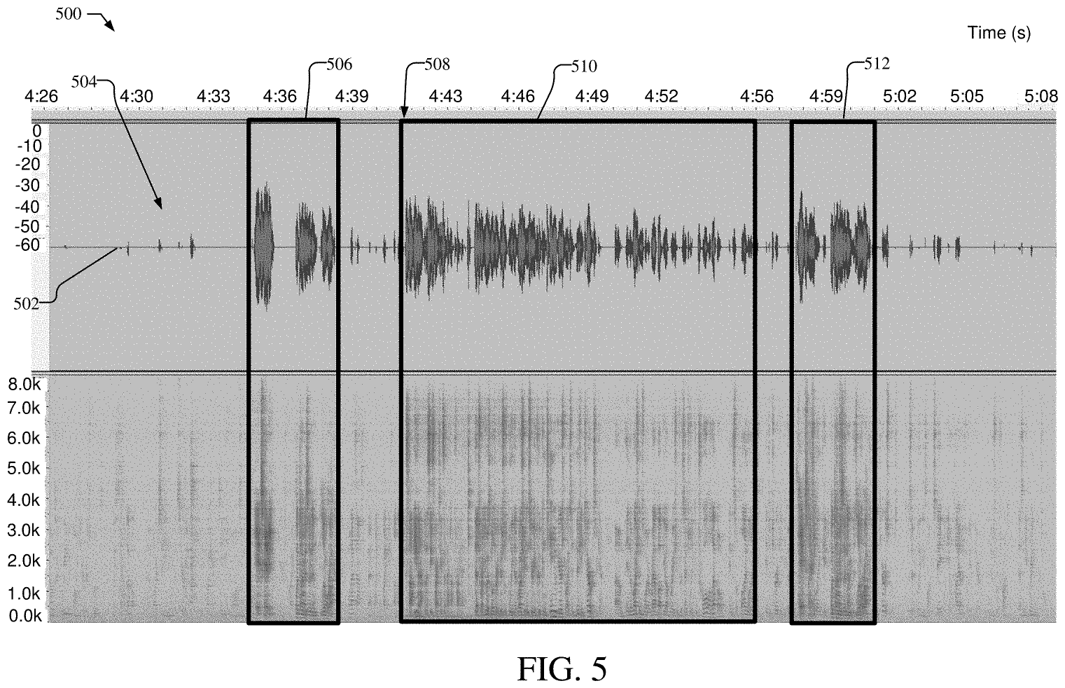

FIG. 5 illustrates a timing diagram 500 for an audio input signal 502 and illustrates noise reduction in the input signal in response to the detection of movement of the voice activated device. The X axis of FIG. 5 represents time and the Y axis represents amplitude of the input signal 502. FIG. 5 shows a sequence of events illustrating noise reduction in the input signal 502 by the noise reduction unit 440 in response to the motion sensor 435 detecting a change in location and/or orientation of a voice activated device 400.

As illustrated by arrow 504 in FIG. 5, the noise reduction unit 440 may initially suppress environmental noise in the input signal 502, e.g., after being initially adapted to the environmental noise. When speech is present in the input signal 502 at box 506, it is clear and easily distinguished from the environmental noise.

Movement of the voice activated device 400 is detected by the motion sensor 435 at the arrow 508 and the noise reduction unit 540 is switched to active mode in response. As illustrated by box 510, the input signal 502 that is received by the noise reduction unit 540 includes environmental, but does not include speech. By receiving a noise only signal, the noise reduction unit 540 may adapt to the environmental noise at the new location and/or orientation of the voice activated device 400. After a preconfigured amount of time or in response to an indication from the noise reduction unit 540 that environmental noise is adequately suppressed, the noise reduction unit 540 may be switched back to idle mode, e.g., at the end of box 510. Accordingly, when speech is detected in the input signal 502 (after movement of voice activated device 400 and adaptation to noise from the new location or orientation), the speech is clear and easily distinguished from the environmental noise, e.g., as illustrated by box 512.

In an additional or alternative implementation, movement of the voice activated device 400 may be measured by the motion sensor 435 and motion information, e.g., displacement and/or rotation of the voice activated device 400, may be provided to the noise reduction unit 440. The noise reduction unit 440 may use the motion information to perform noise reduction in the audio signal 412.

In one implementation, the motion information may be used by the noise reduction unit 440 to adapt to environmental noise with a relatively short or no adaptation period. For example, the noise reduction unit 440 may be switched to active mode based on sensed movement from the motion sensor 435 and the noise reduction unit 440 may also receive motion information from the motion sensor 435, which may be used to more quickly adapt to environmental noise, e.g., while no speech is present (as illustrated in box 510 in FIG. 5). In another example, the noise reduction unit 440 may receive motion information from the motion sensor 435, but may otherwise remain in idle mode (e.g., the motion information may be stored in a buffer and provided to the noise reduction unit 440 once the noise reduction unit 440 is in active mode). When the VAD 430 detects speech (or other target sound) in the audio signal 412, the noise reduction unit 440 may be switched to active mode and may use the motion information from the motion sensor 435 to quickly adapt to environmental noise.

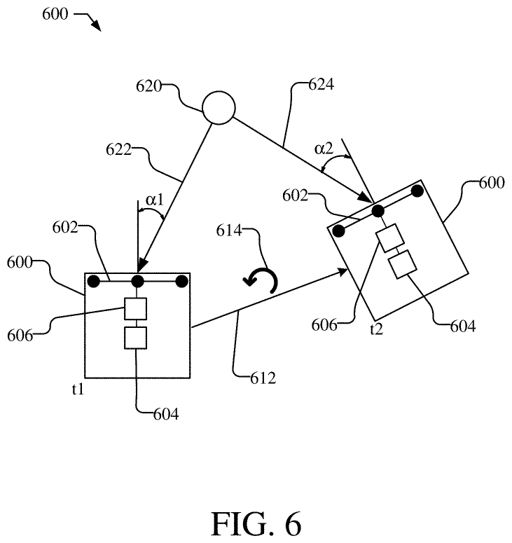

FIG. 6 illustrates an environment that includes a voice activated device 600 and a sound source 620, which may be a noise source or a speech source. The voice activated device 600 may be an example of the voice activated device 400 of FIG. 4. The voice activated device 600 is illustrated as moving (as shown by arrows 612 and 614) between a first location and orientation with respect to the sound source 620 at a first time (t1) to a second location and orientation with respect to the sound source 620 at a second time (t2).

The voice activated device 600 includes a microphone 602, which is illustrated as a microphone array. The microphone 602 uses beam forming to receive sound (illustrated by arrow 622) from the sound source 620 at a first energy level and angle α1. The voice activated device 600 further includes a motion sensor 604, which may include, e.g., one or more accelerometers and/or gyroscopes, compass, etc. The motion sensor 604 measures the linear displacement and/or rotational displacement of the voice activated device 600, illustrated by arrows 612 and 614, when the voice activated device 600 moves from its first location and orientation at the first time (t1) to the second location and orientation at the second time (t2). The motion sensor 604 provides the motion information to the noise reduction unit 606, which uses the measurement information to determine the current direction (e.g., at time t2) of the sound source 620 to quickly adapt to environmental noise. For example, the noise reduction unit 606 may estimate the new direction (e.g., angle α2) and may estimate the second energy level of sound (illustrated by arrow 624) from the sound source 620 at the second time (t2) (after movement of the voice activated device 600) based on the previous direction (angle α1) and energy level of the sound source from the first time t1 (before movement of the voice activated device 600) and the measured linear displacement 612 and rotational displacement 614 as measured by the motion sensor 604.

Thus, the noise reduction unit 606 may use the motion information to make adjustments based on the measured change in location and/or orientation. For example, the estimated new direction of the sound source 620 may be used for a new steering direction for beam forming with the microphone 602 to receive (or suppress) sound from the sound source 620.

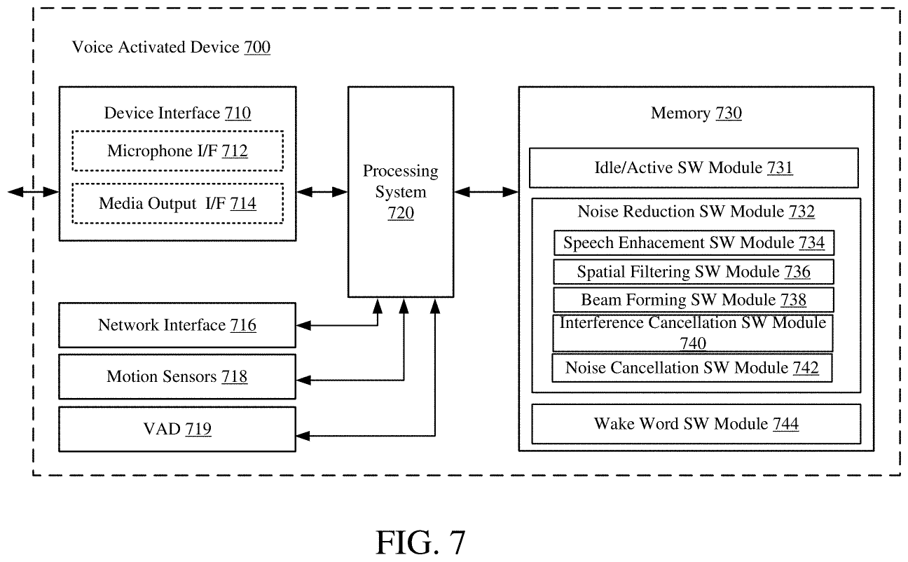

FIG. 7 illustrates a block diagram of an example of a voice activated device 700, according to some implementations. More specifically, the voice activated device 700 may be configured to detect movement and to enhance noise reduction an audio signal in response to the movement, as discussed herein. In some implementations, the voice activated device 700 may be one example of the voice activated device 400 of FIG. 4 or the voice activated device 600 of FIG. 6. The voice activated device 700, or a portion of the voice activated device may be a controller for enhancing noise reduction in response to movement. The voice activated device 700 is illustrated as including a device interface 710, a network interface 716, one or more motion sensors 718, a VAD 719, a processing system 720, and a memory 730. It should be understood that additional components may be included in the voice activated device 700.

The device interface 710 is configured to communicate with one or more components of a voice active system. In some implementations, the device interface 710 may include a microphone interface (I/F) 712, a media output interface 714, and a network interface 716. The microphone interface 712 may communicate with a microphone of the voice activated device 700 (e.g., microphone 410 of FIG. 4 and/or microphone 602 of FIG. 6). For example, the microphone interface 712 may receive audio signals from the microphone and in some implementations may provide control signals to the microphone, e.g., to control beam forming.

The media output interface 714 may be used to communicate with one or more media output components of the voice activated device 700. For example, the media output interface 714 may transmit information and/or media content to the media output components (e.g., speakers and/or displays) to render a response to a user's voice input or query.

The network interface 716 may be used to communicate with a network resource external to the voice activated device 700. For example, the network interface 716 may transmit voice queries to, and receive results from, the network resource.

The one or more motion sensors 718 may include one or more accelerometers, one or more gyroscopes, a magnetometer, a digital compass, or any combination thereof. In some implementations, the one or more motion sensors 718 may sense the occurrence of linear movement or rotational movement and produce a control signal when movement is sensed. In some implementations, the one or more motion sensors 718 may generate motion information, such as measured linear and/or rotational displacement. It should be understood that the processing system 720 (or another processing system) may operate with the one or more motion sensors 718 to generate the motion information based on the raw signals produced by the one or more motion sensors 718.

The VAD 719 is a voice activity detector that detect the presence or absence of speech (or other trigger sound) within an audio signal received via microphone interface 712. While VAD 719 is illustrated as a separate component in FIG. 7, it should be understood that VAD 719 may be implemented in hardware and/or software. Moreover, VAD 719 may be coupled to receive audio signal directly from the microphone, from the microphone interface 712, or from the processing system 720. Moreover, the VAD 719 may be included in the microphone itself or may be a part of a codec chip or in any component in the audio flow.

The processing system 720 may include any suitable one or more processors capable of executing scripts or instructions of one or more software programs stored in the voice activated device 700 (such as in memory 730). The processing system 720 may be implemented using a combination of hardware, firmware, and software. In some embodiments, the processing system 720 may represent one or more circuits configurable to perform at least a portion of a data signal computing procedure or process related to the operation of voice activated device 700.

The memory 730 may include a non-transitory computer-readable medium (including one or more nonvolatile memory elements, such as EPROM, EEPROM, Flash memory, or a hard drive, among other examples) that may store one or more of software (SW) modules that contain executable code or software instructions that when executed by the processing system 720 cause the one or more processors in the processing system 720 to operate as a special purpose computer programmed to perform the techniques disclosed herein. While the components or modules are illustrated as software in memory 730 that is executable by the one or more processors in the processing system 720, it should be understood that the components or modules may be stored in memory 730 or may be dedicated hardware either in the one or more processors of the processing system 720 or off the processors. It should be appreciated that the organization of the contents of the memory 730 as shown in voice activated device 700 is merely exemplary, and as such the functionality of the modules and/or data structures may be combined, separated, and/or be structured in different ways depending upon the implementation of the voice activated device 700.

The memory 730 may include an idle/active SW module 731 that when implemented by the processing system 720 configures one or more processors to receive a control signal from the VAD 719, and in some implementations from the one or more motion sensors 718 and to switch one or more components of the voice activated device 700, including the noise reduction unit, between idle mode an active mode in response to the control signals. In some implementations, the one or more processors may be configured to receive signals from other components in the voice activated device 700 indicating when speech is no longer present in the audio signal so that components may be switched from an active mode to an idle mode.

The memory 730 may include a noise reduction SW module 732 that when implemented by the processing system 720 configures one or more processors to reduce noise in a received audio signal, when the noise reduction is in active mode. The noise reduction SW module 732, for example, may include one or more sub-modules for noise reduction. For example, a speech enhancement SW module 734 may configure one or more processors in the processing system 720 to enhance the speech in the audio signal, e.g., via one or more temporal or frequency filters. A spatial filtering SW module 736 may configure one or more processors in the processing system 720 to spatially filter the audio signal, e.g., via beam forming. A beam forming SW module 738 may configure one or more processors in the processing system 720 to perform adaptive beam forming, e.g., to adjust or steer beams of a microphone array to direct receive beams towards a desired sound source or away from a noise source. An interference cancellation SW module 740 may configure one or more processors in the processing system 720 to perform adaptive interference cancellation. A noise cancellation SW module 742 may configure one or more processors in the processing system 720 to perform adaptive noise cancellation.

The memory 730 may include a wake word SW module 744 that when implemented by the processing system 720 configures one or more processors to identify a wake word (or other target noise) in a received audio signal when in active mode.

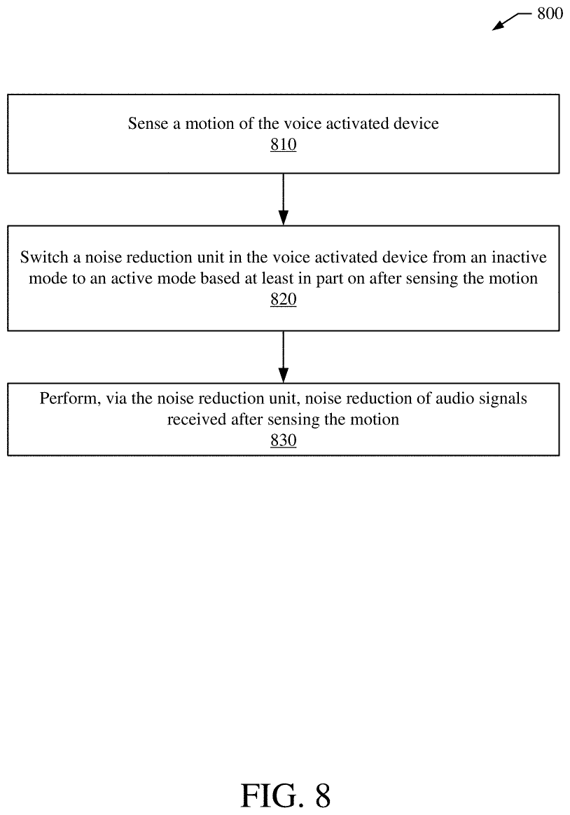

Each software module includes instructions that, when executed by the one or more processors of the processing system 720, cause the voice activated device 700 to perform the corresponding functions. The non-transitory computer-readable medium of memory 730 thus includes instructions for performing all or a portion of the operations described below with respect to FIG. 8.

FIG. 8 shows an illustrative flowchart depicting an example operation 800 for processing audio signals, according to implementations described herein. In some implementation, the example operation 800 may be performed by a voice activated device, such as voice activated devices 400, 600, or 700 of FIGS. 4, 6, and 7, respectively.

As illustrated, the voice activated device may sense a motion of the voice activated device (810), e.g., as discussed in reference to FIGS. 4, 5, 6, and 7. For example, a controller may include a processing system, such as illustrated in FIG. 7, that is configured to sense a motion of the voice activated device. The motion of the voice activated device be sensed, e.g., using motion sensor 435, motion sensor 604, or the one or more motion sensors 718 and the processing system 720 configured with dedicated hardware or implementing executable code or software instructions in memory 730, illustrated in FIGS. 4, 6, and 7, respectively.

The voice activated device may switch a noise reduction unit in the voice activated device from an inactive mode to an active mode based at least in part on sensing the motion (820), e.g., as discussed in reference to FIGS. 4, 5, 6, and 7. For example, a controller may include a processing system, such as illustrated in FIG. 7, that is configured to switch noise reduction in the voice activated device from an inactive mode to an active mode based at least in part on sensing the motion. The noise reduction unit may be configured to switch from an inactive mode to an active mode based at least in part on sensing the motion e.g., using switch 420 or the processing system 720 configured with dedicated hardware or implementing executable code or software instructions in memory 730, such as the idle/active SW module 731, illustrated in FIGS. 4 and 7, respectively.

The voice activated device may perform, via the noise reduction unit, noise reduction of audio signals received after sensing the motion (830), e.g., as discussed in reference to FIGS. 4, 5, 6, and 7. In some aspects, the noise reduction of audio signals may be one or more of speech enhancement, signal-to-noise ratio (SNR) enhancement, spatial filtering, beam forming, interference cancellation, noise cancelation, or any combination thereof. For example, a controller may include a processing system, e.g., as illustrated in FIG. 7, that is configured to perform noise reduction of audio signals received after the motion is sensed. The noise reduction unit may be configured to perform noise reduction of audio signals received after the motion is sensed, e.g., using noise reduction unit 440, noise reduction unit 606, or the processing system 720 configured with dedicated hardware or implementing executable code or software instructions in memory 730, such as the noise reduction SW module 732 (and optionally one or more sub-modules), illustrated in FIGS. 4, 6, and 7, respectively.

In some aspects, switching the noise reduction unit from the inactive mode to the active mode may be in response to sensing the motion, and performing the noise reduction of the audio signals received after sensing the motion may include adapting to environmental noise in the audio signals before switching from the active mode back to the inactive mode.

For example, in some aspects, after adapting to the environmental noise in the audio signals, the voice activated device may further detect speech in audio signals, e.g., as discussed in reference to FIGS. 2, 4, and 5. The speech in audio signals may be detected using VAD 430 or VAD 719 and the processing system 720 configured with dedicated hardware or implementing executable code or software instructions in memory 730, illustrated in FIGS. 4 and 7, respectively. The noise reduction unit may be switched from the inactive mode to the active mode in response to detecting the speech, wherein the noise reduction unit is adapted to the environmental noise in the audio signals, e.g., as discussed in reference to FIGS. 4 and 5. For example, switching the noise reduction unit from the inactive mode to the active mode in response to detecting the speech may use, e.g., switch 420 or the processing system 720 configured with dedicated hardware or implementing executable code or software instructions in memory 730, such as the idle/active SW module 731, illustrated in FIGS. 4 and 7, respectively.

In some aspects, the voice activated device may further generate motion information from sensing the motion, and wherein performing the noise reduction after sensing the motion uses the motion information, e.g., as discussed in reference to FIGS. 4 and 6. For example, motion information may be generated from the sensed motion using, e.g., motion sensor 435, motion sensor 604, or the one or more motion sensors 718 and the processing system 720 configured with dedicated hardware or implementing executable code or software instructions in memory 730, illustrated in FIGS. 4, 6, and 7, respectively.

For example, in some aspects, the voice activated device may further detect speech after sensing the motion, and wherein switching the noise reduction unit from the inactive mode to the active mode is in response to detecting the speech, e.g., as discussed in reference to FIGS. 4 and 6. Speech may be detected after sensing the motion using VAD 430 or VAD 719 and the processing system 720 configured with dedicated hardware or implementing executable code or software instructions in memory 730, illustrated in FIGS. 4 and 7, respectively.

For example, in some aspects, the voice activated device may further determine a steering direction for beam forming to receive the audio signals based on a steering state before sensing the motion and the motion information, and wherein performing the noise reduction after sensing the motion uses the steering direction, e.g., as discussed in reference to FIGS. 4 and 6. For example, a steering direction may be determined for beam forming to receive the audio signals based on a steering state before sensing the motion and the motion information, and wherein the noise reduction may be performed after sensing the motion based on the steering direction using, e.g., noise reduction unit 440, noise reduction unit 606, or the processing system 720 configured with dedicated hardware or implementing executable code or software instructions in memory 730, such as the noise reduction SW module 732 (and optionally one or more sub-modules such as beam forming SW module 738), illustrated in FIGS. 4, 6, and 7, respectively.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of processing audio signals in a voice activated device, comprising:
sensing a motion of the voice activated device;
switching a noise reduction unit in the voice activated device from an inactive mode to an active mode based at least in part on sensing the motion; and
performing, via the noise reduction unit, noise reduction of audio signals received after sensing the motion.

2. The method of claim 1, wherein performing noise reduction of audio signals comprises one or more of speech enhancement, signal-to-noise ratio (SNR) enhancement, spatial filtering, beam forming, interference cancellation, noise cancelation, or any combination thereof.

3. The method of claim 1, wherein switching the noise reduction unit from the inactive mode to the active mode is in response to sensing the motion, and wherein performing the noise reduction of the audio signals received after sensing the motion comprises adapting to environmental noise in the audio signals before switching from the active mode back to the inactive mode.

4. The method of claim 3, wherein after adapting to the environmental noise in the audio signals, the method further comprises:
detecting speech in audio signals; and
switching the noise reduction unit from the inactive mode to the active mode in response to detecting the speech, wherein the noise reduction unit is adapted to the environmental noise in the audio signals.

5. The method of claim 1, further comprising generating motion information from sensing the motion, and wherein performing the noise reduction after sensing the motion uses the motion information.

6. The method of claim 5, further comprising detecting speech after sensing the motion, and wherein switching the noise reduction unit from the inactive mode to the active mode is in response to detecting the speech.

7. The method of claim 5, further comprising determining a steering direction for beam forming to receive the audio signals based on a steering state before sensing the motion and the motion information, and wherein performing the noise reduction after sensing the motion uses the steering direction.

8. A controller for a voice activated device, comprising:
at least one memory; and
a processing system comprising one or more processors coupled to and the at least one memory, the processing system configured to:
sense a motion of the voice activated device;
switch noise reduction in the voice activated device from an inactive mode to an active mode based at least in part on sensing the motion; and
perform the noise reduction of audio signals received after the motion is sensed.

9. The controller of claim 8, wherein the processing system is configured to perform noise reduction of audio signals by being configured to perform one or more of speech enhancement, signal-to-noise ratio (SNR) enhancement, spatial filtering, beam forming, interference cancellation, noise cancelation, or any combination thereof.

10. The controller of claim 8, wherein the processing system is configured to switch the noise reduction from the inactive mode to the active mode in response to sensing the motion, and wherein the processing system is configured to perform the noise reduction of the audio signals received after the motion is sensed by being configured to adapt to environmental noise in the audio signals before switching from the active mode back to the inactive mode.

11. The controller of claim 10, wherein after adapting to the environmental noise in the audio signals, the processing system is configured to:
detect speech in audio signals; and
switch the noise reduction from the inactive mode to the active mode in response to the speech being detected, wherein the processing system is adapted to the environmental noise in the audio signals.

12. The controller of claim 8, wherein the processing system is further configured to generate motion information from the motion, and wherein the processing system is configured to perform the noise reduction after the motion is sensed using the motion information.

13. The controller of claim 12, wherein the processing system is further configured to detect speech after the motion is sensed, and wherein the processing system is configured to switch the noise reduction from the inactive mode to the active mode in response to the speech being detected.

14. The controller of claim 12, wherein the processing system is further configured to determine a steering direction for beam forming to receive the audio signals based on a steering state before sensing the motion and the motion information, and wherein the processing system is configured to perform the noise reduction after the motion is sensed using the steering direction.

15. A voice activated device, comprising:
one or more motion sensors configured to sense a motion of the voice activated device; and
a noise reduction unit configured to:
switch from an inactive mode to an active mode based at least in part on the sensed motion; and
perform noise reduction of audio signals received after the motion is sensed.

16. The voice activated device of claim 15, wherein the noise reduction unit is configured to perform noise reduction of audio signals by being configured to perform one or more of speech enhancement, signal-to-noise ratio (SNR) enhancement, spatial filtering, beam forming, interference cancellation, noise cancelation, or any combination thereof.

17. The voice activated device of claim 15, wherein the noise reduction unit is configured to switch from the inactive mode to the active mode in response to the motion being sensed, and to perform the noise reduction of the audio signals received after the motion is sensed by adapting to environmental noise in the audio signals before switching from the active mode back to the inactive mode.

18. The voice activated device of claim 17, wherein the noise reduction unit is configured to:
switch from the inactive mode to the active mode in response to detection of speech in the audio signals after the noise reduction unit is adapted to the environmental noise in the audio signals.

19. The voice activated device of claim 15, wherein the noise reduction unit is further configured to receive motion information, and to perform the noise reduction after the motion is sensed using the motion information.

20. The voice activated device of claim 19, wherein the noise reduction unit is further configured to switch from the inactive mode to the active mode in response to detection of speech in the audio signal.

21. The voice activated device of claim 19, wherein the noise reduction unit is further configured to determine a steering direction for beam forming to receive the audio signals based on a steering state before the motion is sensed and the motion information, and wherein the noise reduction unit is configured to perform the noise reduction after the motion is sensed using the steering direction.
